(19) United States
(12) Patent Application Publication
(10) Pub. No.: US 2007/0178383 A1
(43) Pub. Date: Aug. 2, 2007

(54) CURRENT COLLECTOR

(76) Inventors: Joseph J. Viavattine, Vadnais Heights, MN (US); Hailiang Zhao, Maple Grove, MN (US)

Correspondence Address: MEDTRONIC, INC., 710 MEDTRONIC PARKWAY NE, MINNEAPOLIS, MN, 55432-9924, US

(21) Appl. No.: 11/380,250

(22) Filed: Apr. 26, 2006

Related U.S. Application Data
(63) Continuation-in-part of application No. 11/343,320, filed on Jan. 31, 2006.

(51) Int. Cl. H01M 4/70; H01M 4/66; B32B 15/01

(52) U.S. Cl. 429/241; 429/245; 428/615; 429/128

(57) ABSTRACT

A current collector for a battery in an implantable medical device is presented. The current collector comprises a layer which includes a first surface and a second surface. For a cathode electrode plate, the layer possesses a lower resistivity of less than or about 2.7 Ohm meters (Ω [symbol] )×10⁸. For an anode electrode plate, the layer possesses a resistivity of about 2.5 Ω [symbol] ×10⁸ to about 7 Ωm×10⁸.

### CROSS-REFERENCE TO RELATED APPLICATION

This application is a continuation-in-part of non-provisional U.S. patent application Ser. No. 11/343,320 filed on Jan. 31, 2006, which is incorporated in its entirety.

### FIELD OF THE INVENTION

The present invention generally relates to a battery for an implantable medical device and, more particularly, to current collectors in an electrode assembly of the battery.

### BACKGROUND OF THE INVENTION

Implantable medical devices (IMDs) detect and deliver therapy for a variety of medical conditions in patients. IMDs include implantable pulse generators (IPGs) or implantable cardioverter-defibrillators (ICDs) that deliver electrical stimuli to tissue of a patient. ICDs typically comprise, inter alia, a control module, a capacitor, and a battery that are housed in a hermetically sealed container. When therapy is required by a patient, the control module signals the battery to charge the capacitor, which in turn discharges electrical stimuli to tissue of a patient.

The battery includes a case, a liner, an electrode assembly, and electrolyte. The liner insulates the electrode assembly from the case. The electrode assembly includes electrodes, an anode and a cathode, with a separator therebetween. For a flat plate battery, an anode comprises a set of anode electrode plates with a set of tabs extending therefrom. The set of tabs are electrically connected. Each anode electrode plate includes a current collector with anode material disposed thereon. A cathode is similarly constructed.

Electrolyte, introduced to the electrode assembly via a fill port in the case, is a medium that facilitates ionic transport and forms a conductive pathway between the anode and cathode. An electrochemical reaction between the electrodes and the electrolyte causes charge to be stored on the cathode.

### BRIEF DESCRIPTION OF THE DRAWINGS

The present invention will become more fully understood from the detailed description and the accompanying drawings, wherein:

FIG. 1 is a cutaway perspective view of an implantable medical device (IMD);

FIG. 2 is a cutaway perspective view of a battery in the IMD of FIG. 1;

FIG. 3A is an enlarged view of a portion of an electrode assembly depicted in FIG. 2;

FIG. 3B is a cross-sectional view of a portion of an electrode assembly depicted in FIG. 2;

FIG. 4A is an angled cross-sectional view of a current collector in an electrode plate of the electrode assembly depicted in FIG. 3A;

FIG. 4B is an angled cross-sectional view of the electrode plate that includes the current collector depicted in FIG. 4A along with electrode material disposed thereon;

FIG. 5 is a top perspective view of a current collector;

FIG. 6 is a flow diagram for forming a current collector for a battery;

FIG. 7 is a top perspective view of a wrap that connects tabs from anode electrode plates in the electrode assembly depicted in FIG. 3A; and

FIG. 8 is a top perspective view of a conductive coupler that connects tabs from electrode plates.

### DETAILED DESCRIPTION

The following description of embodiments is merely exemplary in nature and is in no way intended to limit the invention, its application, or uses. For purposes of clarity, the same reference numbers are used in the drawings to identify similar elements.

The present invention is directed to a battery in an implantable medical device (IMD). The battery includes an electrode assembly that comprises a set of electrode plates. Each electrode plate includes a current collector with electrode material disposed thereon. The current collector includes a layer that has a first surface and a second surface. A set of apertures extend from the first surface to the second surface of the layer. Cathode current collectors consist essentially of aluminum. Anode current collectors consist essentially of copper and/or nickel. The current collectors may be used in high reliability primary battery cells (e.g. lithium ion, etc.) or the like.

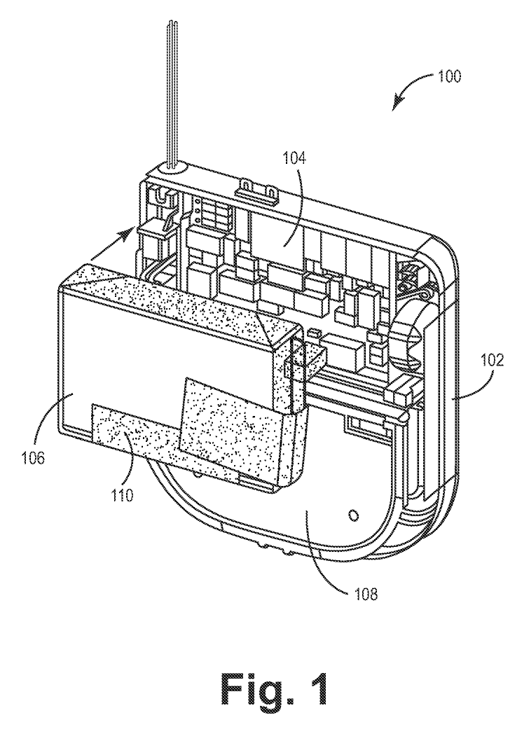

FIG. 1 depicts an IMD 100 (e.g. implantable cardioverter-defibrillators (ICDs) etc.). IMD 100 includes a case 102, a control module 104, a battery 106 (e.g. organic electrolyte battery etc.) and capacitor(s) 108. Control module 104 controls one or more sensing and/or stimulation processes from IMD 100 via leads (not shown). Battery 106 includes an insulator 110 (or liner) disposed therearound. Battery 106 charges capacitor(s) 108 and powers control module 104.

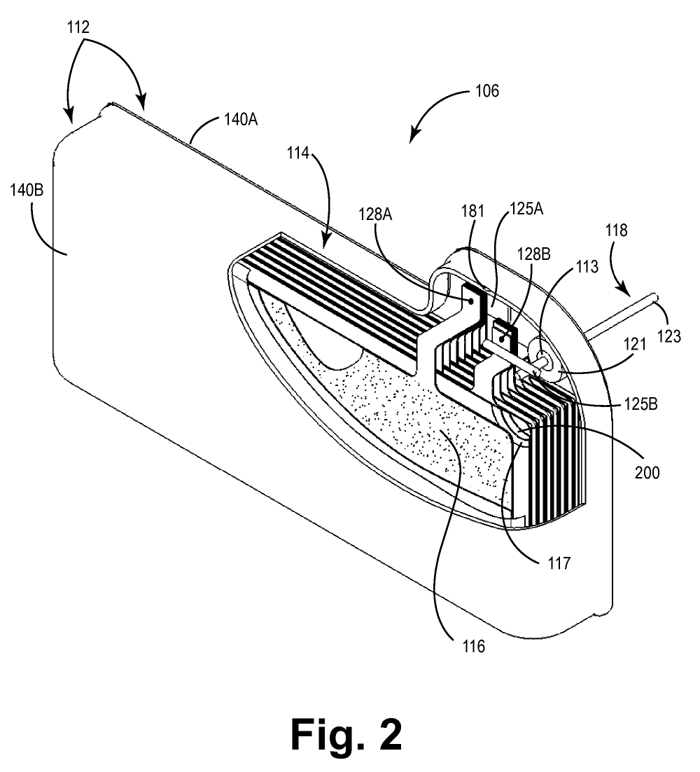

FIGS. 2 through 5 depict details of an exemplary organic electrolyte battery 106. Battery 106 includes an encasement 112, a feed-through terminal 118, a fill port 181 (partially shown), a liquid electrolyte 116, and an electrode assembly 114. Encasement 112, formed by a cover 140A and a case 140B, houses electrode assembly 114 with electrolyte 116. Feed-through assembly 118, formed by pin 123, insulator member 113, and ferrule 121, is electrically connected to jumper pin 125B. The connection between pin 123 and jumper pin 125B allows delivery of positive charge from electrode assembly 114 to electronic components outside of battery 106.

Fill port 181 (partially shown) allows introduction of liquid electrolyte 116 to electrode assembly 114. Electrolyte 116 creates an ionic path between anode 115 and cathode 119 of electrode assembly 114. Electrolyte 116 serves as a medium for migration of ions between anode 115 and cathode 119 during an electrochemical reaction with these electrodes.

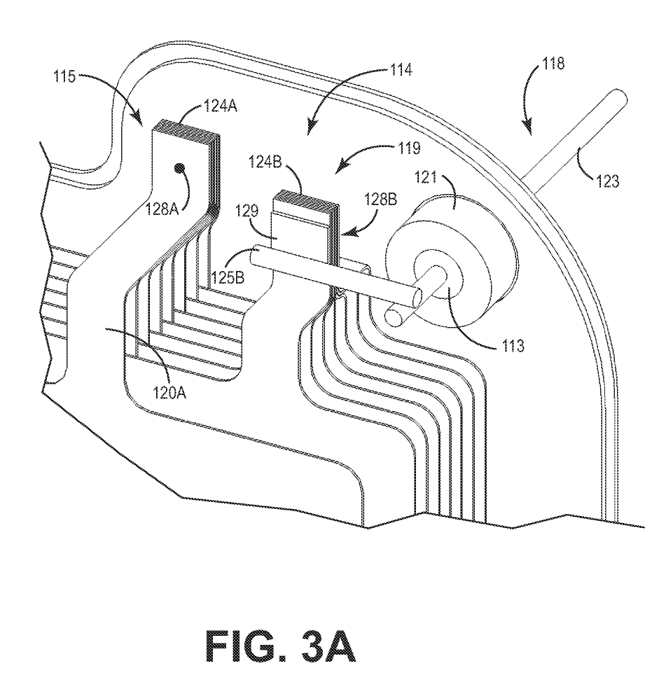

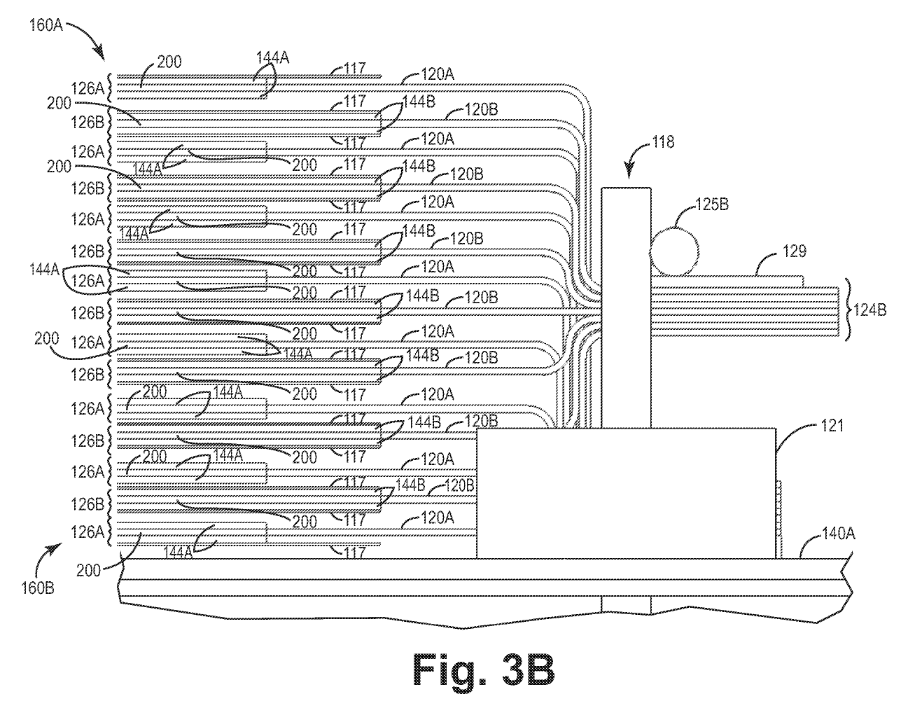

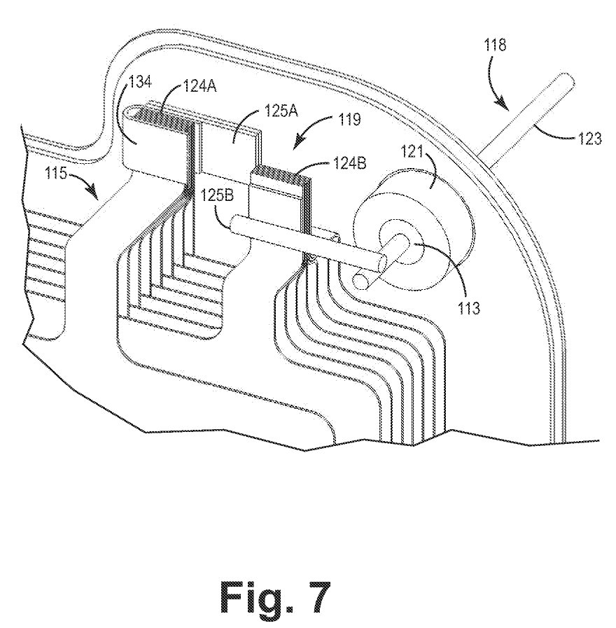

Referring to FIGS. 3A-3B, electrode assembly 114 is depicted as a stacked assembly. Anode 115 comprises a set of electrode plates 126A (i.e. anode electrode plates) with a set of tabs 124A that are conductively coupled via a conductive coupler 128A (also referred to as an anode collector). Conductive coupler 128A may be a weld or a separate coupling member, as described below relative to FIG. 7. Optionally, conductive coupler 128A is connected to an anode interconnect jumper 125A, as shown in FIG. 2.

Each electrode plate 126A includes a current collector 200 or grid, a tab 120A extending therefrom, and electrode material 144A. Tab 120A comprises conductive material (e.g. copper, etc.). Electrode material 144A includes elements from Group IA, IIA or IIIB of the periodic table of elements (e.g. lithium, sodium, potassium, etc.), alloys thereof, intermetallic compounds (e.g. Li—Si, Li—B, Li—Si—B etc.), or an alkali metal (e.g. lithium, etc.) in metallic form. As shown in FIG. 3B, a separator 117 is coupled to electrode material 144A at the top and bottom 160A-B electrode plates 126A, respectively.

Cathode 119 is constructed in a similar manner as anode 115. Cathode 119 includes a set of electrode plates 126B (i.e. cathode electrode plates), a set of tabs 124B, and a conductive coupler 128B connecting set of tabs 124B. Conductive coupler 128B or cathode collector is connected to conductive member 129 and jumper pin 125B. Conductive member 129, shaped as a plate, comprises titanium, aluminum/titanium clad metal or other suitable materials. Jumper pin 125B is also connected to feed-through assembly 118, which allows cathode 119 to deliver positive charge to electronic components outside of battery 106. Separator 117 is coupled to each cathode electrode plate 126B.

Each cathode electrode plate 126B includes a current collector 200 or grid, electrode material 144B and a tab 120B extending therefrom. Tab 120B comprises conductive material (e.g. aluminum etc.). Electrode material 144B or cathode material includes metal oxides (e.g. vanadium oxide, silver vanadium oxide (SVO), manganese dioxide etc.), carbon monofluoride and hybrids thereof (e.g., CF_{X}+MnO₂), combination silver vanadium oxide (CSVO), lithium ion, other rechargeable chemistries, or other suitable compounds.

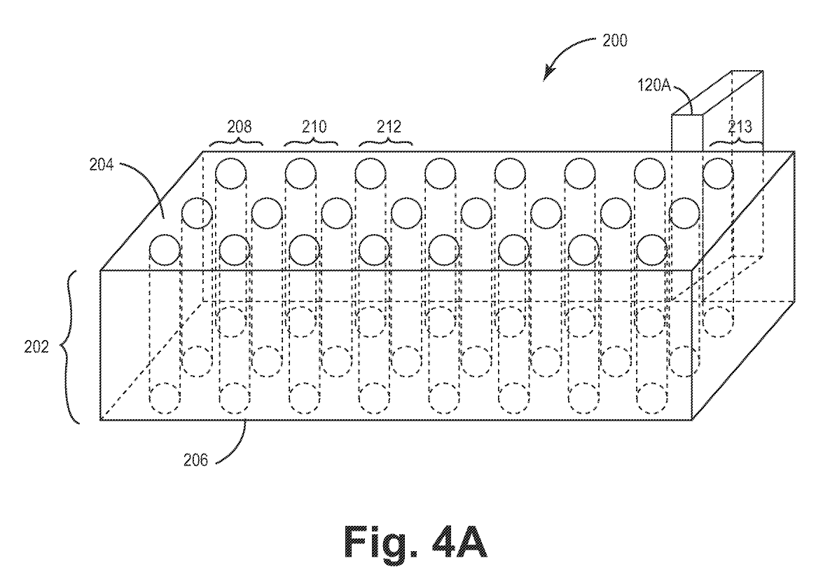

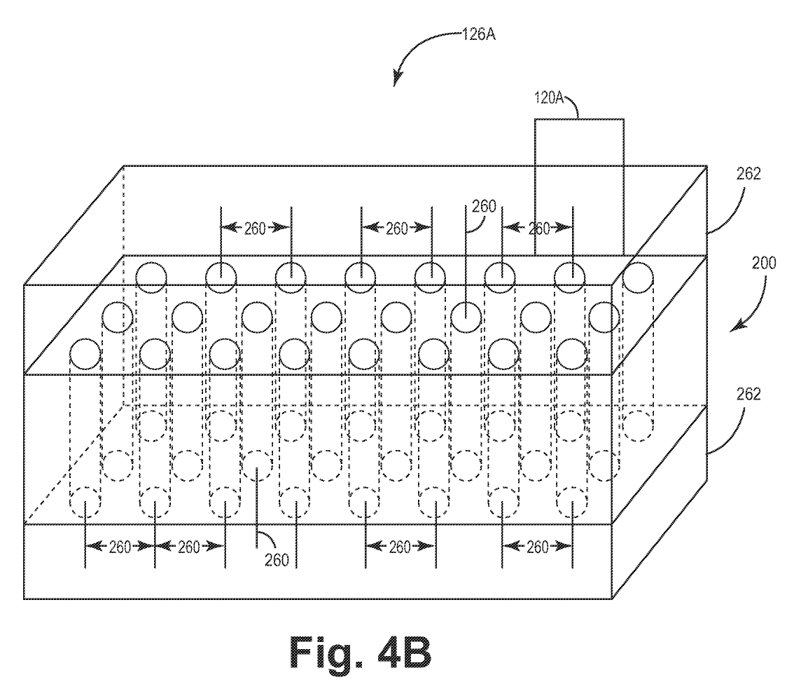

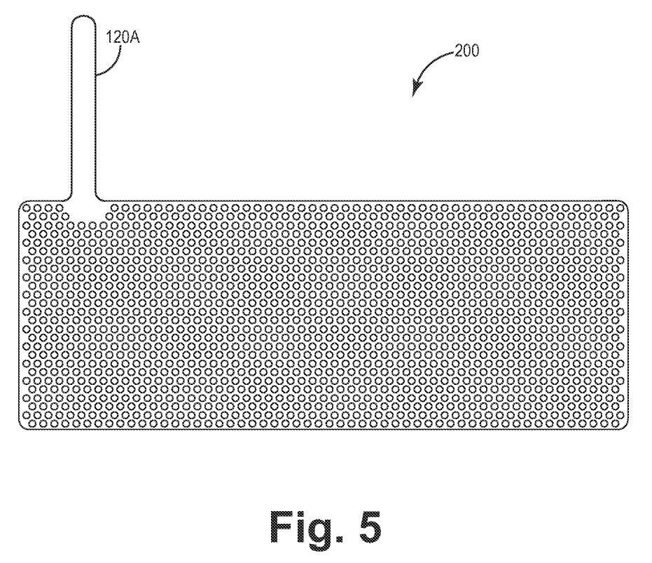

FIGS. 4A-4B and 5 depict details of current collector 200. Current collector 200 is a layer 202 that includes a first surface 204 and a second surface 206 with a connector tab 120A protruding therefrom. A first, second, third, and N set of apertures 208, 210, 212, 213, respectively, extend from first surface 204 through second surface 206. N set of apertures are any whole number of apertures.

For an anode 115, current collector 200 consists essentially of nickel or copper. In comparison, for cathode 119, current collector 200 consists essentially of aluminum. As shown below in Table 1, aluminum, copper, or nickel possess a significantly lower resistivity than titanium. For example, copper exhibits a resistivity of 1.7 Ohm meter (Ωm)×10⁸) compared to 40 Ωm×10⁸ in titanium.

TABLE 1
Resistivity and Thermal Conductivity for Materials

| | | Thermal Conductivity |
|---|---|---|
| | | (Watts/meter Kelvin |
| Material | Resistivity (Ohm meter (Ωm) × 10⁸) | (W/mK)) |
| Titanium | 40.0 | 22 |
| Aluminum | 2.7 | 235 |
| Copper | 1.7 | 400 |
| Nickel | 7.0 | 91 |

Referring to FIG. 4B, apertures 208, 210, 212, 213 in current collector 200 allows electrode material 262 (i.e. electrode material 144A or electrode material 144B) to electrostatically interact to form bonds 260. Bonds 260 ensure that electrode material 262 does not delaminate from current collector 200.

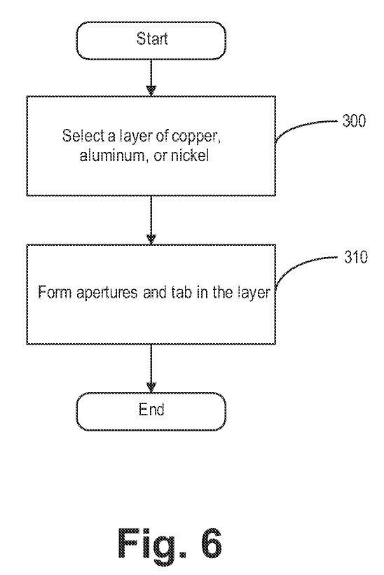

FIG. 6 is a flow diagram for forming an exemplary electrode plate. At block 300, a layer with a first surface and a second surface is provided. The material consists essentially of copper or nickel for an anode. The material consists essentially of aluminum for a cathode. Using these types of materials for the cathode and anode current collectors reduces electrode areas and current collector thicknesses, which results in reduced volume of battery 106. For example, the volume of battery 106 may be reduced up to 10 percent (%). Alternatively, the volume of battery 106 may be reduced up to 5%. At block 310, a set of apertures are formed in the layer along with a tab extending from the layer.

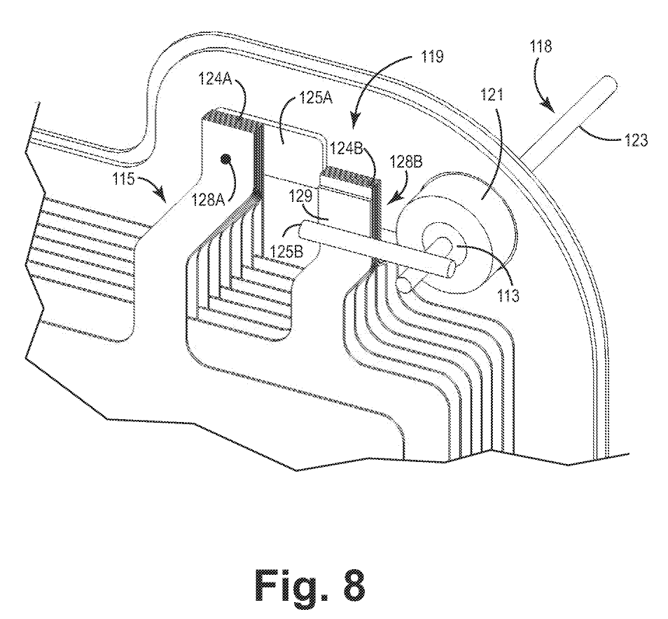

Although various embodiments of the invention have been described and illustrated with reference to specific embodiments thereof, it is not intended that the invention be limited to such illustrative embodiments. For example, FIGS. 7 and 8 depict the various means for conductively connecting the set of tabs extending from the set of electrode plates. Conductive coupler 128A is a conductive wrap 134A (FIG. 7) such as nickel connected to clad material (i.e. nickel/titanium clad metal). In an alternate embodiment, FIG. 8 illustrates an anode interconnect jumper 125A (e.g. a vanadium jumper) welded to cover 140A and to set of tabs 124A extending from the set of the anode electrode plates. In yet another embodiment, current collector 200 for an anode comprises a metal or alloy that exhibit a resistivity of less than 7 Ωm×10⁸. Exemplary alloys include at least two metals selected from the group comprising aluminum, copper, and nickel. In still yet another embodiment, current collector 200 for a cathode generally comprises a metal or alloy that exhibit a resistivity of less than 2.7 Ωm ×10⁸. Exemplary alloys include at least two metals selected from the group comprising aluminum, copper, and nickel.

The description of the invention is merely exemplary in nature and, thus, variations that do not depart from the gist of the invention are intended to be within the scope of the invention. Such variations are not to be regarded as a departure from the spirit and scope of the invention.

1. A cathode current collector for a plate battery in an implantable medical device comprising:
a layer which includes a first surface and a second surface, the layer possesses a lower resistivity of less than or about 2.7 Ohm meters(Ωm)×10⁸; and
a set of apertures extend from the first surface to the second surface of the layer.

2. The cathode current collector of claim 1, wherein the layer possesses a thermal conductivity of about 235 Watts/meter Kelvin (W/mK).

3. The cathode current collector of claim 1, wherein the layer consists essentially of aluminum.

4. The cathode current collector of claim 1, wherein the layer reduces a size of the battery by about 5 percent (%).

5. An anode current collector for a flat plate battery in an implantable medical device comprising:
a layer which includes a first surface and a second surface, wherein the layer possesses a resistivity of about 2.5 Ωm×10⁸ to about 7 Ωm×10⁸; and
a set of apertures extend from the first surface to the second surface of the layer.

6. The current collector of claim 5, wherein the layer possesses a thermal conductivity of about 91 W/mK to about 400 W/mK.

7. The current collector of claim 1, wherein the layer comprises one of copper and nickel.

8. The current collector of claim 1, wherein the layer reduces a volumetric size of the battery by about 10%.

9. A plate battery in an implantable medical device comprising:
(a) an anode that includes a set of anode electrode plates with a set of tabs extending therefrom, the anode comprises:
a set of anode current collectors, each anode current collector comprises one of copper and nickel and includes a first set of apertures that extend from the first surface to the second surface of the anode current collector, each anode current collector covered with an anodic material;
(b) a cathode that includes a set of cathode electrode plates with a set of tabs extending therefrom, the cathode comprises:
a set of cathode current collectors, each cathode current collector comprises aluminum and includes a second set of apertures that extend from the first surface to the second surface of the cathode current collector, each cathode current collector covered with a cathodic material;
(c) a set of separators disposed between each anode electrode plate and cathode electrode plate; and
an electrolyte disposed over the anode and the cathode.

10. The plate battery of claim 9, further comprising:
a set of anode tabs extending from the set of anode collectors; and
a conductive coupling member coupled to the set of anode tabs and to a case of the battery.

11. The plate battery of claim 10, the coupling member comprising one of titanium, and nickel/titanium.

12. The plate battery of claim 10, wherein the coupling member being a wrap.

13. The plate battery of claim 10, wherein the coupling member being a vanadium jumper.

14. The plate battery of claim 10, wherein the coupling member comprising one of clad material, and vanadium.

15. The plate battery of claim 14, wherein the clad material being selected based upon at least one welding property associated with a case of the battery.

16. The plate battery of claim 15, wherein the clad material being selected based upon at least one welding property associated with the set of anode tabs.

17. The plate battery of claim 14, wherein the clad material being nickel/titanium clad metal.

18. The plate battery of claim 14, wherein the clad material comprising a first metal being at least one of aluminum, copper, nickel, and titanium.

19. The plate battery of claim 18, wherein the clad material comprising a second metal being different from the first metal, the second metal being at least one of aluminum, copper, nickel, and titanium.

20. A method of forming a current collector for a plate battery in an implantable medical device comprising:
providing a layer of copper; and
forming a set of apertures in the copper layer.
